(19) United States
(12) Patent Application Publication
(10) Pub. No.: US 2025/0377086 A1
(43) Pub. Date: Dec. 11, 2025

(54) ARRANGEMENTS FOR ADJUSTABLE LIGHT DISTRIBUTION AND LIGHT ANGLE AND LIGHT FIXTURES PROVIDED THEREWITH

(71) Applicant: Shenzhen Jiangjing Lighting Co., Ltd., Shenzhen (CN)

(72) Inventors: Gao Li, Shenzhen (CN); Yibo Xu, Shenzhen (CN); Ming Tan, Shenzhen (CN)

(21) Appl. No.: 19/230,076

(22) Filed: Jun. 5, 2025

Related U.S. Application Data
(60) Provisional application No. 63/656,563, filed on Jun. 5, 2024.

(51) Int. Cl. F21V 5/00; F21S 8/06; F21V 5/08; F21W 131/103; F21Y 103/10; F21Y 103/33; F21Y 105/12; F21Y 115/10

(52) U.S. Cl. CPC F21V 5/007; F21S 8/06; F21V 5/08; F21W 2131/103; F21Y 2103/10; F21Y 2103/33; F21Y 2105/12; F21Y 2115/10

(57) ABSTRACT

A light fixture is provided herein including: a plurality of side-by-side arrays each containing a set of solid state light generating elements, wherein each array is independently powered; and, a plurality of lenses provided for each of the arrays, the lenses each covering one or more solid state light generating elements and being fixed to a substrate, wherein first lenses of a first array having a first height, second lenses of a second array having a second height greater than the first height, whereby different beam angles and light patterns are achievable by activating different arrays, individually or in various combinations. Advantageously, with the subject invention, a light fixture may be provided where different beam angles and light patterns are achievable without physically changing components of the light fixture.

### CROSS-REFERENCE TO RELATED FILING

This application claims priority to U.S. Provisional Patent Appl. No. 63/656,563, filed Jun. 5, 2024, the entire contents of which is incorporated by reference herein.

### BACKGROUND OF THE INVENTION

### Background of LED Lighting Fixture Technology

Lighting devices are typically comprised of a fixture body, LED driver and light strips. These light strips are equipped with multiple LED chips or other light sources. During illumination, the light strips are powered by connecting them to a power source, such as a LED driver, and supplying specific voltage and current to drive multiple LED groups on the strips. The current passes through the LED semiconductor layer, exciting electrons and releasing energy. This energy is then emitted in the form of light, resulting in the illumination of the LED chips. The brightness of the LED chips is determined by current.

Issues with Existing Technology

In real-world lighting applications, there are different requirements for light patterns and light angles. Existing lighting technologies often attach different lenses to the outer edge of LED light strips to achieve the light pattern and light angle. It makes inconvenient to adjust light patterns and light angles in real-time according to actual needs, particularly where physical lenses are required to be changed.

### SUMMARY OF THE INVENTION

A light fixture is provided herein including: a plurality of side-by-side arrays each containing a set of solid state light generating elements, wherein each array is independently powered; and, a plurality of lenses provided for each of the arrays, the lenses each covering one or more solid state light generating elements and being fixed to a substrate, wherein first lenses of a first array having a first height, second lenses of a second array having a second height greater than the first height, whereby different beam angles and light patterns are achievable by activating different arrays, individually or in various combinations. Advantageously, with the subject invention, a light fixture may be provided where different beam angles and light patterns are achievable without physically changing components of the light fixture.

### BRIEF DESCRIPTION OF THE FIGURES

FIGS. 1-4 show a linear high bay light fixture with the beam angle of the generated light being altered in accordance with the subject invention;

FIGS. 5-7 show a canopy (shoebox) light fixture with the beam angle of the generated light being altered in accordance with the subject invention;

FIGS. 8-11 show a pendant light fixture with the beam angle of the generated light being altered in accordance with the subject invention;

FIG. 12 shows schematically three light strips having lenses of different heights in accordance with the subject invention;

FIG. 13 shows a light fixture having a plurality of linear arrays having lenses of different heights in accordance with the subject invention;

FIG. 14 is a cross-sectional view taken along line 14-14 of FIG. 13;

FIG. 15 shows a light fixture having a plurality of arcuate arrays having lenses of different heights in accordance with the subject invention;

FIG. 16 is a cross-sectional view taken along line 16-16 of FIG. 15;

FIG. 17 shows a light fixture having a plurality of lens each associated with a plurality of solid state light generating elements in accordance with the subject invention; and,

FIG. 18 is a cross-sectional view taken along line 18-18 of FIG. 17.

### DETAILED DESCRIPTION OF THE INVENTION

To address the shortcomings of existing technology, a practical new invention provides a solution to adjust light angle and light pattern, solving the current disadvantage of optical technology's inability to adjust light angle and light pattern in real-time according to actual needs.

With the subject invention, multiple LED chips are positioned at specific locations under lenses, with the LED chips mounted on discrete LED light strips (preferably each having its own substrate). The multiple LED light strips are fixed on a body of a light fixture to form LED light strip groups. The light strips are preferably arranged side-by-side, more preferably, being spaced apart and generally parallel to one another. The light strips may be each loop shaped with the light strips being concentrically arranged about a center of the light fixture. Activating the light strip(s), and portions thereof, in different combinations allows for different light beam angles and distribution patterns, particularly when taken in combination with the lenses described below. The light strips may be combined with one or more control modules (e.g., IC modules (which may include dimming capability)) to control the brightness LED chips at different positions on the light strip(s) to achieve different light distribution with the lenses, individual or in various combinations, altering beams angles to provide different light patterns. The control module(s) may be driven or operated by dip switch, rotary knob, switch, remote control, or mobile application. The light strips may each include a control module. Alternatively, a control module may control two or more light strips, including having a single control module for all light strips.

Each of the light strips is separately electrically powered so as to be independently controlled. In this manner, each of the light strips is independently powered and independently controlled by the control module(s). Each light strip is provided with a plurality of solid state light generating elements, which may be LEDs (light generating diodes), OLEDs (organic light generating diodes), and so forth. In addition, the light strips may be divided into separately controllable sections to allow for independent control of portions of one or more of the light strips.

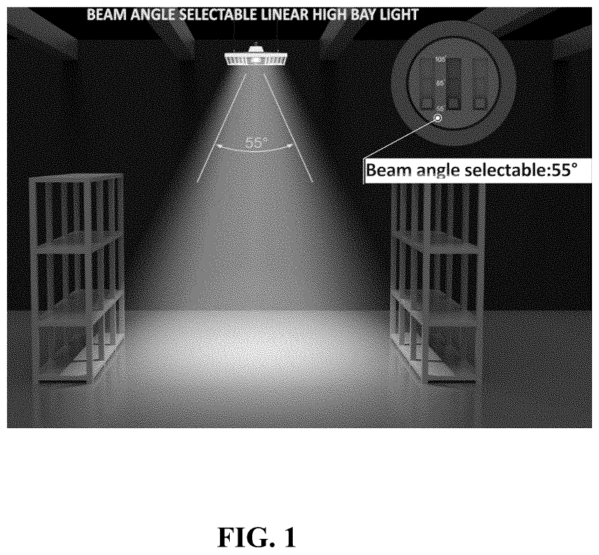

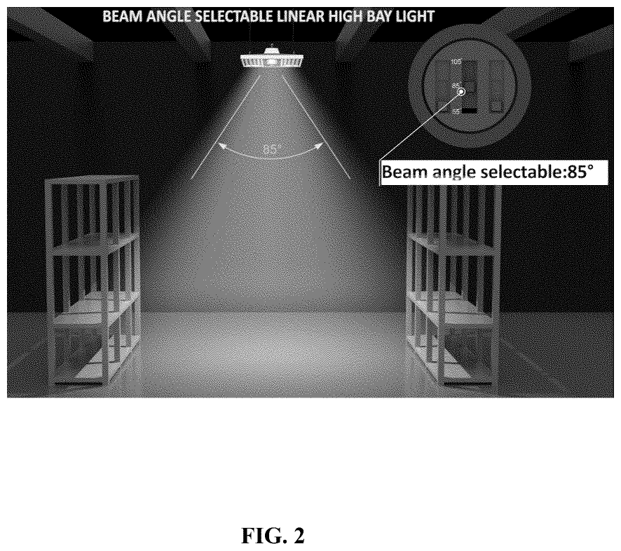

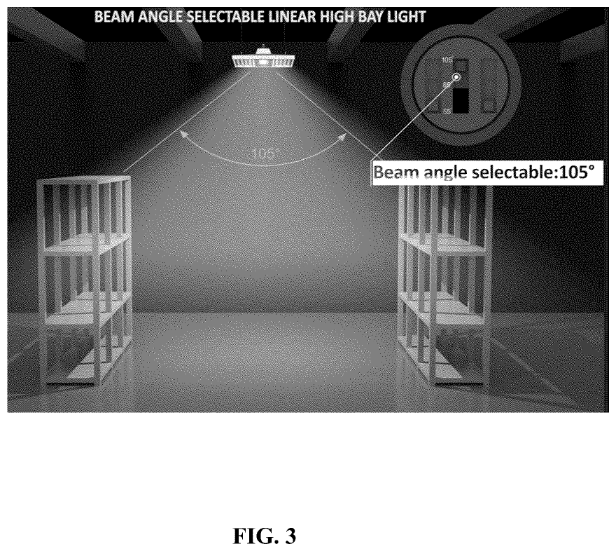

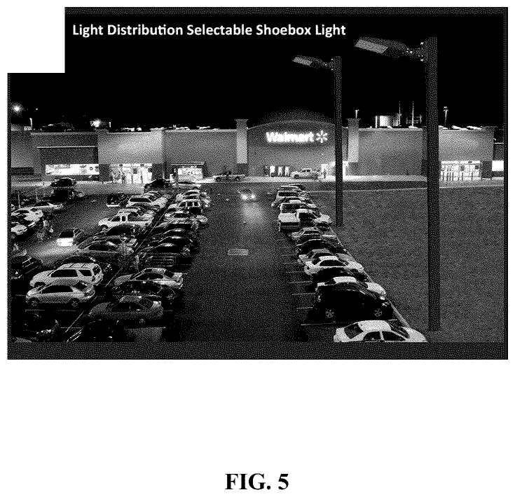

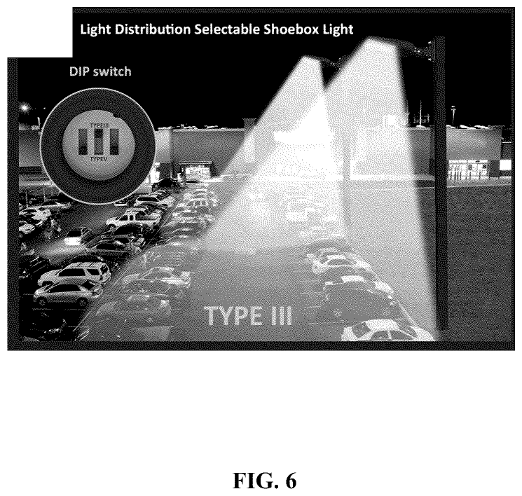

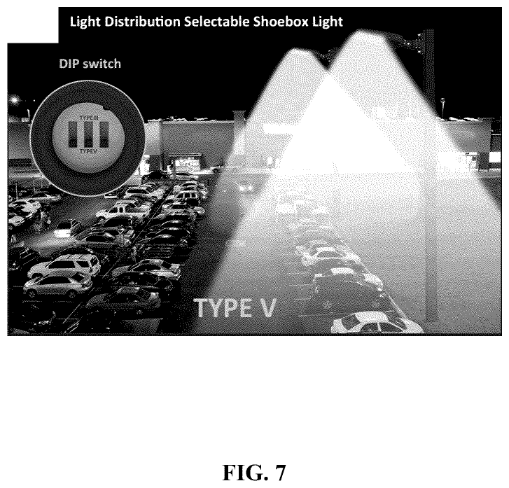

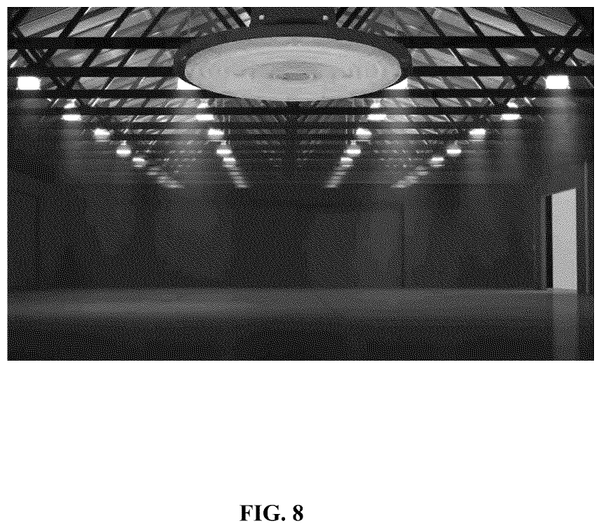

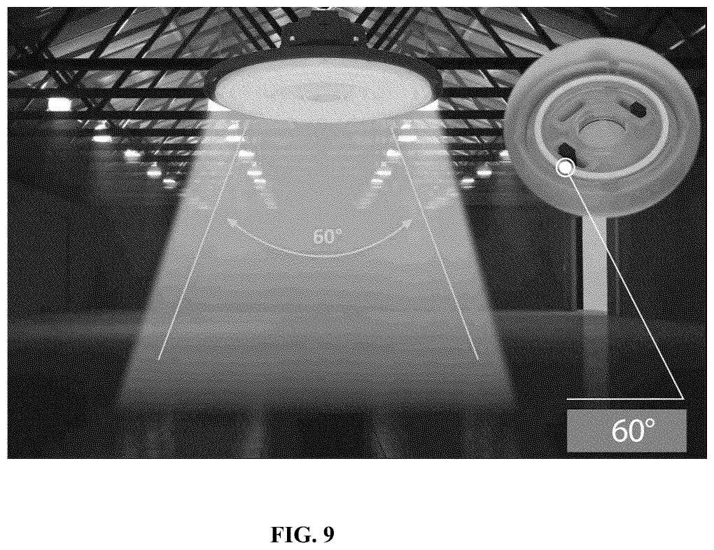

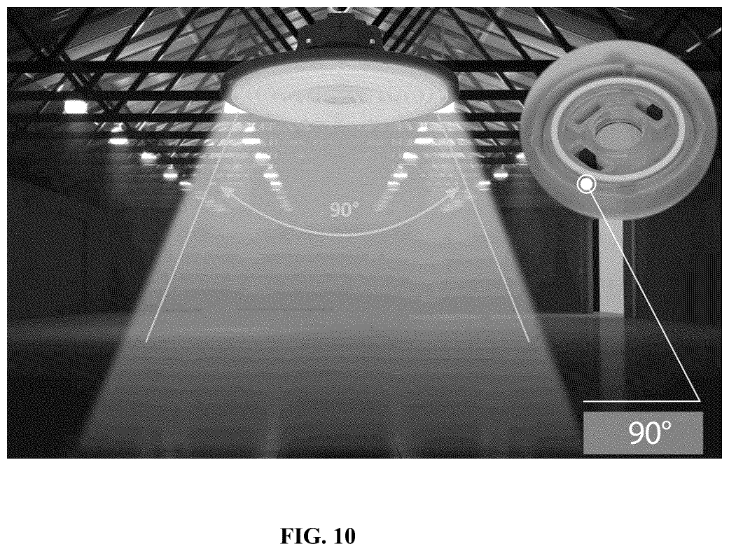

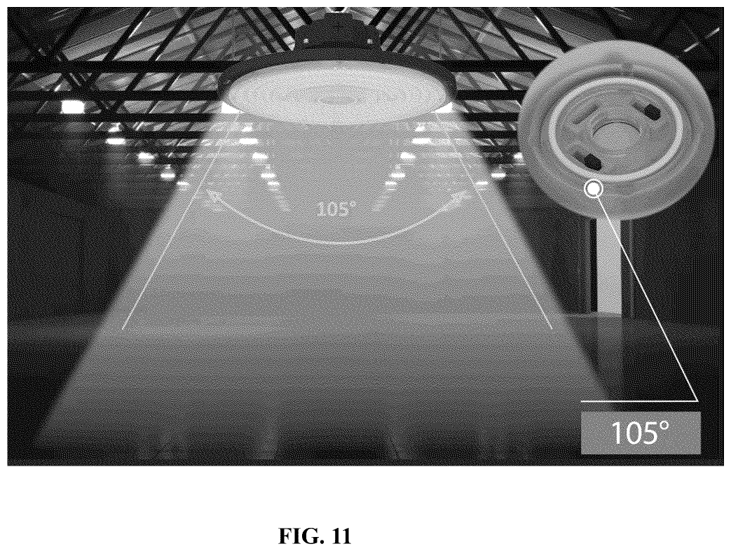

The subject invention allows for a range of altered beam angles providing different light patterns. In this manner, with the same light fixture, different extents of light throw may be achieved. For example, with reference to FIGS. 1-3, a linear high bay light fixture is shown in which the beam angle of the generated light is altered utilizing the subject invention, e.g., between 55 degrees, 85 degrees, and 105 degrees; FIGS. 5-7 show altered beam angles for a canopy (shoebox) light fixture, for example, between Type III and Type V light distribution patterns (as defined by IESNA (Illuminating Engineering Society of North America)); and, FIGS. 8-11 show altered beam angles for a pendant light fixture, being, for example, between 60 degrees, 90 degrees, and 105 degrees. As shown in the figures, the beam angle may be adjusted by a switch located on the fixture. The switch may be manually adjustable (e.g., exposed externally) and/or wirelessly adjustable (e.g., internally housed). As will be appreciated by those skilled in the art, additional and/or different beam angles or light distribution patterns (e.g., Type I, Type II, Type IV) may be utilized beyond the Type III and Type V light distribution patterns discussed above.

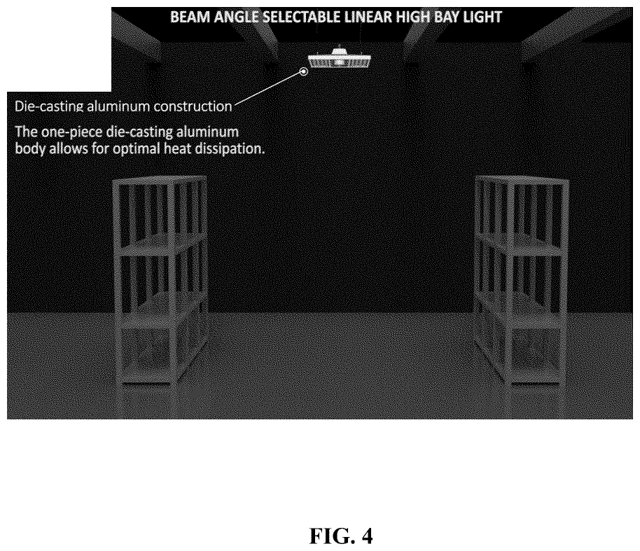

The subject invention may utilize a plurality of fixed beam angle options for a user, for example, three different beam angles as shown in FIGS. 1-11. It is preferred to provide at least a 20 degree (20 degrees <) difference between adjacent pairs of fixed beam angles to provide a user a meaningful difference between settings and an overall wide range (e.g., a difference of at least 40 degrees is provided between the narrowest and widest beam angles where three beam angle settings are offered). Larger differences in beam angle may be utilized, e.g., 25 degrees, 30 degrees, or greater.

With the subject invention, no physical alteration of the light fixture is required (e.g., no physical changing of lens or other elements is required) to achieve a change in beam angle. The beam angle may be changed on-site before, during or after installation, by adjusting a switch (manually or wirelessly).

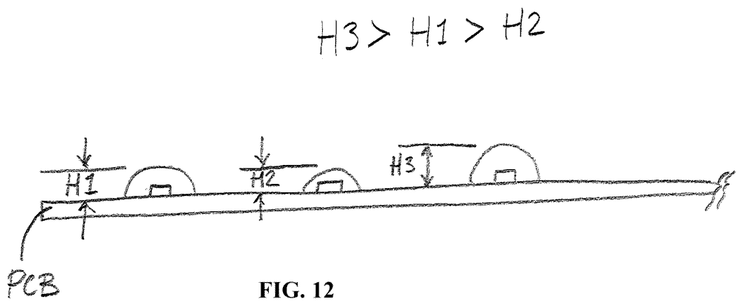

FIG. 12 shows schematically three light strips (viewed from the end). Lenses are provided for each of the light strips which cover one or more solid state light generating elements. Each of the three light strips is lensed differently particularly having different height H1, H2, H3 lenses. The different heights of the different lenses may be configured to provide different beam angles for any light passing therethrough. The subject invention provides for activating particular light strips, with different lensing, to achieve different beam angles. For example, a narrowest beam angle (e.g., 55 degrees) may be achieved by activating the light strip alone with the shortest (lowest height) H2 lenses. A wide beam angle (e.g., 85 degrees) may be achieved by activating the light strips with the two lowest height H1, H2 lenses. The widest beam angle (e.g., 105 degrees) may be achieved by activating all light strips thereby utilizing the lenses of all three heights H1, H2, H3. In a preferred arrangement, the lowest height H2 light strip is located between, and flanked by, the light strips with the greater height H1, H3 lenses. It is further preferred that the intermediate height H1 lenses be located in closer proximity to the outer edge of the light fixture with the greatest height H3 lenses be located interiorly of the two other light strips (i.e., closer to the center of the light fixture). Additional groupings of light strips may be utilized with different height lenses. Different beam angles and light patterns are achieved by controlling the individual light strips through dip switches, rotary knobs, switches, remote controls, and mobile applications to activate specific light strips. With a plurality of light strips, lens height may be the same on two or more strips, used in combination with lenses of other heights on other light strip(s). For example, using the heights referenced above, three light strips may be provided with lenses having heights H3, H1, H1, arranged concentrically from the interior and outward.

Depending on the profile of the light fixture (rectangular, circular), the light strips are arranged to generally follow the outline of the profile, preferably being symmetrically arranged relative to the center of the light fixture (e.g., being arranged in a rectangular loop or a circular loop). Other arrangements are possible including being independent of the light fixture profile.

The lenses described herein are provided on each light strip to cover one or more solid state light generating elements with the lenses being secured to the substrate of the respective light strip. The lenses are separate from a diffuser which may be provided across the entire light fixture through which all light passes. For the lenses, only discrete portions of light pass through each lens, that light being generated by the solid state light generating elements enclosed by the respective lens. The lenses may be optically configured to alter light passing therethrough, e.g., being focused, diffused, etc., to achieve desired beam angle. The lenses may be optically configured uniformly or configured in different manners in a same light fixture (including lenses which are not optically configured). Any form of diffuser may be utilized, including one having light altering characteristics.

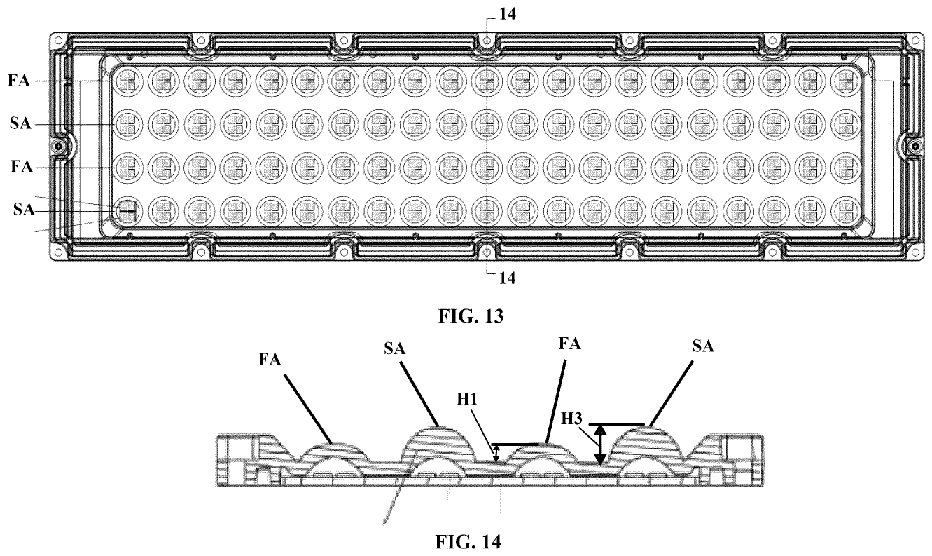

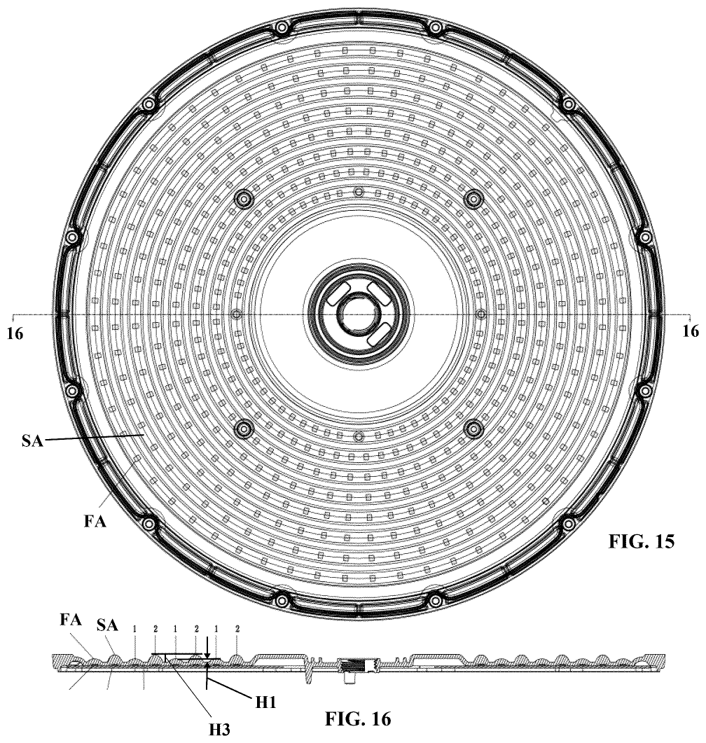

The light strips may be provided as distinct arrays on a common substrate, such as on a common printed circuit board. For example, as shown in FIGS. 13 and 16, a plurality of arrays may be provided with each containing a set of solid state light generating elements. Preferably, the arrays are arranged in parallel and like the light strips are separately controlled. FIG. 13 shows arrays which are arranged linearly. FIG. 15 shows arrays arranged arcuately.

As shown in FIG. 14, a first array FA may include first lenses having the first height H1 and a second array SA may include second lenses having the third height H3, the third height H3 being greater than the first height H1. Moreover, the light fixture may be provided with alternating arrays of the first and second lenses as shown in FIG. 14. With the configuration of FIGS. 13-14, activation of the arrays only having the first lenses results in a first beam angle which is relatively broad (e.g., 105 degrees) (the arrays having the second lenses not being activated or being less activated than the arrays having the first lenses). In contrast, activation of the arrays only having the second lenses results in a second beam angle which is relatively narrow, being smaller than the first beam angle (e.g., 55 degrees) (the arrays having the first lenses not being activated or being less activated than the arrays having the second lenses). It is possible to activate both the arrays having the first lenses and the arrays having the second lenses, being activated evenly, with a third beam angle being generated which is intermediate the first and second beam angles (e.g., 85 degrees). As will be understood by those skilled in the art, the first and second beam angles may be generated with slightly or partially activated arrays in the background which are not fully inactive (e.g., a ratio of 3:7 or 4:6 between the two arrays). The beam angle can be further controlled by altering the ratio of brightness (level of activation) between the two arrays.

The configuration of FIGS. 15-16 operates similarly to the configuration of FIGS. 13-14. As shown in FIG. 16, a first array FA may include first lenses having the first height H1 and a second array SA may include second lenses having the third height H3, the third height H3 being greater than the first height H1. Moreover, the light fixture may be provided with alternating arrays of the first and second lenses as shown in FIG. 16. With the configuration of FIGS. 15-16, activation of the arrays only having the first lenses results in a first beam angle which is relatively broad (e.g., 105 degrees) (the arrays having the second lenses not being activated or being less activated than the arrays having the first lenses). In contrast, activation of the arrays only having the second lenses results in a second beam angle which is relatively narrow, being smaller than the first beam angle (e.g., 60 degrees) (the arrays having the first lenses not being activated or being less activated than the arrays having the second lenses). It is possible to activate both the arrays having the first lenses and the arrays having the second lenses, being activated evenly, with a third beam angle being generated which is intermediate the first and second beam angles (e.g., 90 degrees). As will be understood by those skilled in the art, the first and second beam angles may be generated with slightly or partially activated arrays in the background which are not fully inactive (e.g., a ratio of 3:7 or 4:6 between the two arrays). The beam angle can be further controlled by altering the ratio of brightness (level of activation) between the two arrays.

As shown in FIG. 14, a plurality of solid state light generating elements may be associated with one or more of the lenses. The plurality of solid state light generating elements may be covered by the associated lens. Even numbers of the solid state light generating elements may be provided for each lens (2, 4, 6 . . . ). The characteristics of each grouping of solid state light generating elements may be altered, for example, having different color temperatures (e.g., 3000K vs. 5000K), to allow for further control over light output. It is preferred that the grouping be evenly distributed by the different characteristics. For example, with four of the solid state light generating elements, two of the elements may be provided with one color temperature (e.g., 3000K) while two other elements may be provided with a second color temperature (e.g., 5000K). It is also preferred that similar solid state light generating elements be arranged together; for example, with four of the solid state light generating elements, two of the elements with one color temperature may be located side by side and the other two elements with a second color temperature being side by side, with the two pairs being symmetrically arranged about a center axis.

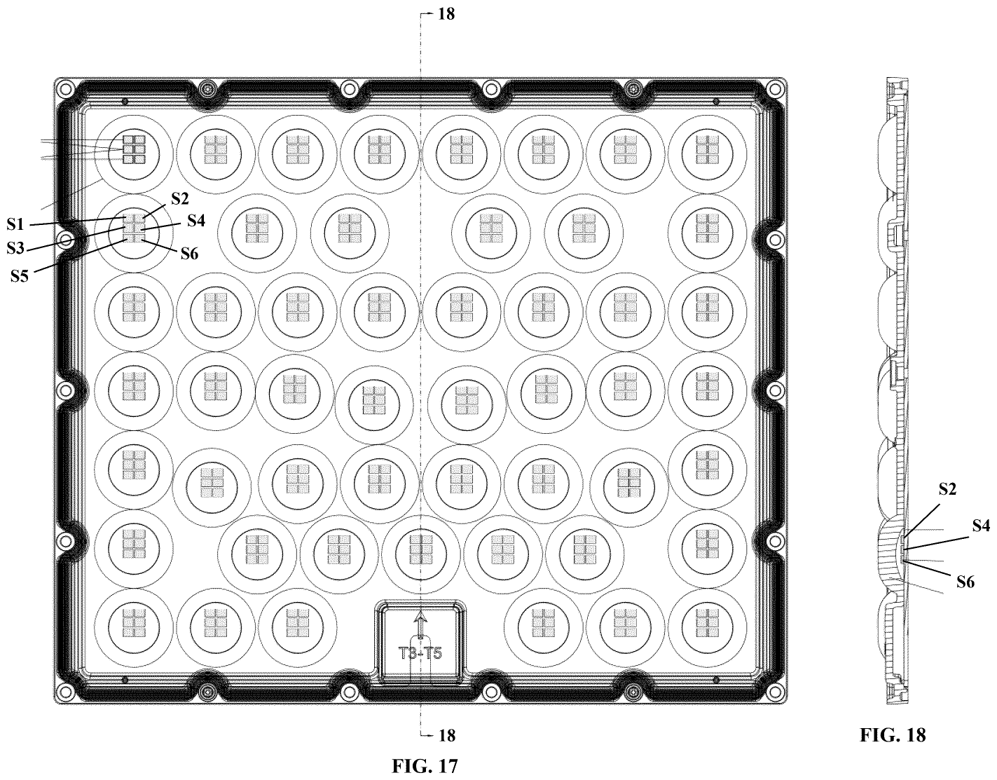

With respect to FIGS. 17-18, a light fixture is shown having a plurality of lenses, each associated with a plurality of solid state light generating elements. FIGS. 17-18 specifically show six solid state light generating elements (S1-S6) associated with each lens. Each lens fully covers the associated grouping of solid state light generating elements. It has been found that beam angle can be changed by activating subsets of the groupings of solid state light generating elements. For example, the activation of elements S1-S4 generates one beam angle (e.g., Type III) while activation of elements S3-S6 generates a second beam angle (e.g., Type IV) different from that generated by elements S1-S4, while activation of elements S1-S6 generates a third beam angle (e.g., Type IV) which is different from both the first and second beam angles. In this manner, beam angle may be controlled. It is noted that in this configuration, the lenses are shown to generally have the same height. The heights may be varied as discussed above, in addition to the use subset activation.

What is claimed is:

1. A light fixture comprising:
a plurality of side-by-side arrays each containing a set of solid state light generating elements, wherein each array is independently powered;
a plurality of lenses provided for each of the arrays, the lenses each covering one or more solid state light generating elements and being fixed to a substrate, wherein first lenses of a first array having a first height, second lenses of a second array having a second height greater than the first height, whereby different beam angles and light patterns are achievable by activating different arrays, individually or in various combinations.

2. The light fixture of claim 1, wherein third lenses of a third array have a third height which is greater than both the first and second heights.

3. The light fixture of claim 1, wherein each array is independently controlled.

4. The light fixture of claim 1, wherein each array is affixed to a strip.

5. The light fixture of claim 1, wherein the arrays are affixed to a common printed circuit board.

6. The light fixture of claim 1, wherein the first and second arrays are parallel.

7. The light fixture of claim 6, wherein the first and second arrays are each arranged linearly.

8. The light fixture of claim 6, wherein the first and second arrays are each arranged arcuately.

9. The light fixture of claim 1, wherein the first and second arrays are each arranged linearly.

10. The light fixture of claim 1, wherein the first and second arrays are each arranged arcuately.

11. The light fixture of claim 1, wherein the first array includes a plurality of solid state light generating elements associated with one of the first lenses.

12. The light fixture of claim 11, wherein the plurality of light solid state light generating elements is covered by the associated first lens.

13. The light fixture of claim 1, wherein the arrays include alternating arrays including the first lenses and the second lenses.
